(19) United States
(12) Patent Application Publication
(10) Pub. No.: US 2026/0164498 A1
(43) Pub. Date: Jun. 11, 2026

(54) CSI-RS AVAILABILITY AND MEASUREMENT REQUIREMENT IN CELL DTX

(71) Applicant: Apple Inc., Cupertino, CA (US)

(72) Inventors: Dan Wu, Beijing (CN); Wei Zeng, Saratoga, CA (US); Dawei Zhang, Saratoga, CA (US); Hong He, San Jose, CA (US); Jie Cui, San Jose, CA (US); Sigen Ye, San Diego, CA (US); Haitong Sun, Saratoga, CA (US); Peng Cheng, Beijing (CN)

(73) Assignee: Apple Inc., Cupertino, CA (US)

(21) Appl. No.: 18/708,591

(22) PCT Filed: May 10, 2023
(86) PCT No.: PCT/CN2023/093306

§ 371 Date: May 8, 2024

(51) Int. Cl. H04W 76/28; H04L 5/00

(52) U.S. Cl. CPC H04W 76/28; H04L 5/0051

(57) ABSTRACT

Provided is a method for a user equipment (UE). The method includes detecting whether a list of Channel State Information-Reference Signal (CSI-RS) resources is configured by a network device for a non-active period of cell discontinuous transmission (DTX) cycle of the network device; and determining whether there are one or more CSI-RSs available during the non-active period of the cell DTX cycle of the network device based on a result of the detection.

### TECHNICAL FIELD

This application relates generally to wireless communication systems, and more specifically to Channel State Information-Reference Signal (CSI-RS) availability and measurement requirement in cell discontinuous transmission (DTX).

### BACKGROUND

Wireless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interoperability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method for a user equipment (UE) is provided that includes: detecting whether a list of Channel State Information-Reference Signal (CSI-RS) resources is configured by a network device for a non-active period of cell discontinuous transmission (DTX) cycle of the network device; and determining whether there are one or more CSI-RSs available during the non-active period of the cell DTX cycle of the network device based on a result of the detection.

According to an aspect of the present disclosure, a method for a user equipment (UE) is provided that includes: determining, based on a preset rule, whether there are one or more Channel State Information-Reference Signals (CSI-RSs) available during a non-active period of cell discontinuous transmission (DTX) cycle of a network device; wherein the preset rule includes: all CSI-RSs being available during the non-active period of the cell DTX cycle; no CSI-RS being available during the non-active period of the cell DTX cycle; or whether there are one or more CSI-RSs available during the non-active period of the cell DTX cycle of the network device being based on whether the cell DTX cycles are configured to align with CSI-RS cycles.

According to an aspect of the present disclosure, a method for a network device is provided that includes: configuring, for transmission to a user equipment (UE), a list of Channel State Information-Reference Signal (CSI-RS) resources for a non-active period of cell discontinuous transmission (DTX) cycle of the network device, wherein whether there are one or more CSI-RSs available during the non-active period of the cell DTX cycle of the network device is determined based on the list of CSI-RS resources.

According to an aspect of the present disclosure, an apparatus for a communication device is provided that includes means for performing steps of the method according to the present disclosure. According to an aspect of the present disclosure, a computer readable medium is provided that has computer programs stored thereon, which when executed by one or more processors, cause an apparatus to perform steps of the method according to the present disclosure.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments of the present disclosure.

FIG. 2 illustrates a flowchart of an exemplary method for a user equipment in accordance with some embodiments of the present disclosure.

FIG. 3 illustrates a flowchart of another exemplary method for a user equipment in accordance with some embodiments of the present disclosure.

FIG. 4 illustrates a flowchart of another exemplary method for a user equipment in accordance with some embodiments of the present disclosure.

FIG. 5A-5F illustrate exemplary diagrams showing the sample intervals for the UE measurement requirement in accordance with some embodiments of the present disclosure.

FIG. 6 illustrates a flowchart of another exemplary method for a user equipment in accordance with some embodiments of the present disclosure.

FIG. 7 illustrates an exemplary diagram showing how the first time window is configured by the network device in accordance with some embodiments of the present disclosure

FIG. 8 illustrates an exemplary diagram showing how the second time window is configured by the network device in accordance with some embodiments of the present disclosure.

FIG. 9 illustrates a flowchart of another exemplary method for a user equipment in accordance with some embodiments of the present disclosure.

FIG. 10 illustrates a flowchart of an exemplary method for a network device in accordance with some embodiments of the present disclosure.

FIG. 11 illustrates a flowchart of exemplary steps for determining availability of CSI-RSs during a non-active period of cell DTX cycle and UE measurement requirement in accordance with some embodiments of the present disclosure.

FIG. 12 illustrates an exemplary block diagram of an apparatus for a UE in accordance with some embodiments of the present disclosure.

FIG. 13 illustrates an exemplary block diagram of an apparatus for a network device in accordance with some embodiments of the present disclosure.

FIG. 14 illustrates example components of a device in accordance with some embodiments of the present disclosure.

FIG. 15 illustrates example interfaces of baseband circuitry in accordance with some embodiments of the present disclosure.

FIG. 16 illustrates components in accordance with some embodiments of the present disclosure.

FIG. 17 illustrates an architecture of a wireless network in accordance with some embodiments of the present disclosure.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In wireless communication, discontinuous transmission/reception (DTX/DRX) of cells or discontinuous reception of UEs is attracting more and more attention due to the beneficial of energy saving. For example, when the network device is configured with a DTX cycle which includes an active period and a non-active period, the network device can operate in the active period of the DTX cycle as normally and operate in a sleep mode in the non-active period of the DTX cycle, thereby saving the energy.

In this context, considering that the channel conditions may change frequently in 5G New Radio (NR) systems, and for the purpose of measurement for the downlink channel quality and reporting to the base station for further adjustment, Channel State Information-Reference Signal (CSI-RS) resources have been provided for UE. Although the CSI-RSs are important for UE throughput and latency performance, it is also energy consuming for the network device to send these CSI-RSs during the non-active period of cell DTX cycles.

In view of the above, methods, apparatuses, computer readable media and computer program products for achieving a compromise between the UE and the network device are provided according to a plurality of embodiments of the present disclosure, which will be described in detail below.

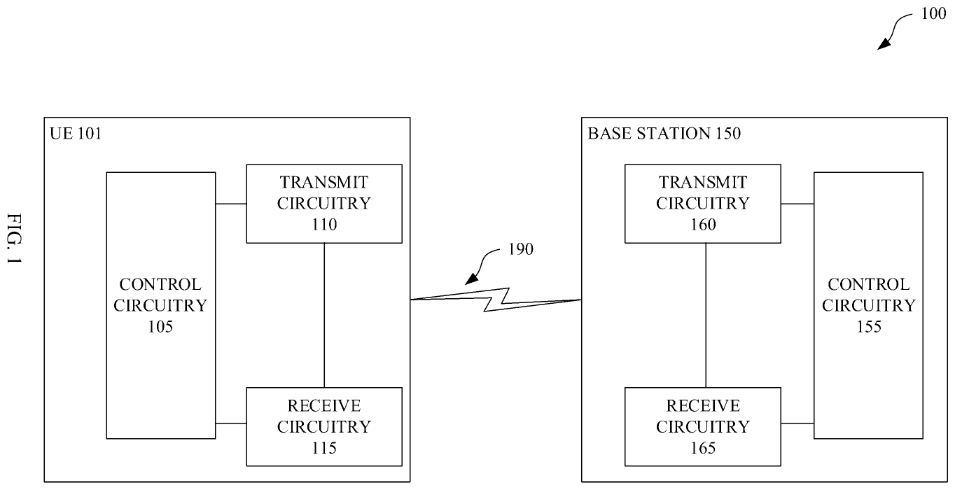

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with MTC. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

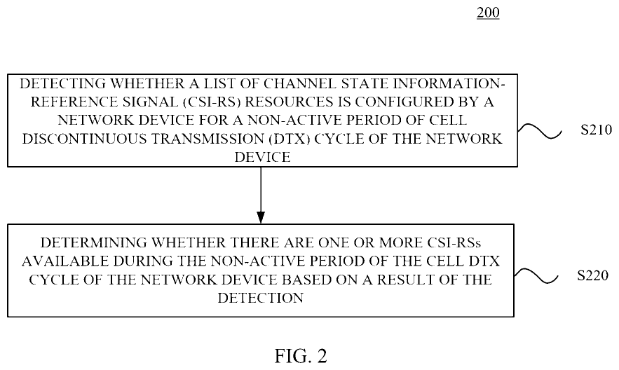

In various embodiments, the UE 101 and the base station 150 described with reference to FIG. 1 may be configured in various ways to implement the UE and the network device described herein. FIG. 2 illustrates a flowchart of an exemplary method for a user equipment in accordance with some embodiments of the present disclosure. The method 200 illustrated in FIG. 2 may be implemented by the UE 101 described with reference to FIG. 1.

Referring FIG. 2, in some embodiments, the method 200 for UE may include the following steps: S210, detecting whether a list of Channel State Information-Reference Signal (CSI-RS) resources is configured by a network device for a non-active period of cell discontinuous transmission (DTX) cycle of the network device; and S220, determining whether there are one or more CSI-RSs available during the non-active period of the cell DTX cycle of the network device based on a result of the detection.

According to some embodiments of the present disclosure, by detecting a list of CSI-RS resources configured by the network device and determining the availability of one or more CSI-RSs during the non-active period of the cell DTX cycle, it is possible for network to utilize the existing signals for transmission of the CSI-RSs or transmit more important CSI-RSs for improving the performance of UE. Accordingly, the throughput and performance such as latency performance can be ensured, and it is not necessary for the network device to send the CSI-RS separately or send all CSI-RSs, thereby reducing the energy consumption.

According to some embodiments of the present disclosure, in step S210, the list of CSI-RS resources may be for a variety purposes, such as for T/F tracking, CSI computation, Layer 1 (L1) Reference Signal Receiving Power (RSRP), L1-Signal to Interference plus Noise Ratio (SINR), mobility, fast Secondary Cell (Scell) activation tracking, or a combination thereof. It should be noted that the above listed purposes of the CSI-RS resources are for better illustration rather than limitation. The network device can configure the list including any suitable CSI-RS resources according to different requirements.

According to some embodiments of the present application, in step S210, the list of CSI-RS resources may be configured together with the cell DTX pattern.

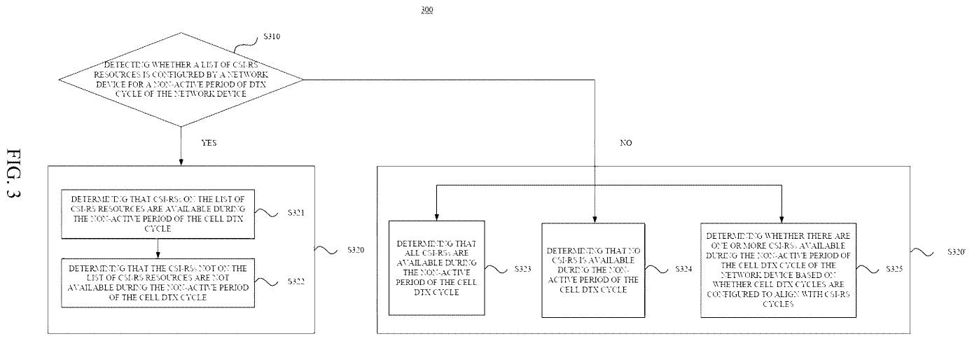

FIG. 3 illustrates a flowchart of another exemplary method 300 for a user equipment in accordance with some embodiments of the present disclosure. As shown FIG. 3, the method 300 for UE may include the steps S310 and S320, which are the same as the steps S210 and S220, wherein step S320, determining whether there are one or more CSI-RSs available during the non-active period of the cell DTX cycle of the network device based on the result of the detection may include step S321, in response to detecting that a list of CSI-RS resources is configured by the network device for the non-active period of the cell DTX cycle of the network device, determining that CSI-RSs on the list of CSI-RS resources are available during the non-active period of the cell DTX cycle; and step S322, in response to detecting that a list of CSI-RS resources is configured by the network device for the non-active period of the cell DTX cycle of the network device, determining that the CSI-RSs not on the list of CSI-RS resources are not available during the non-active period of the cell DTX cycle.

According to some embodiments, in the scenario where the network device does not offload all the legacy UEs to other cells, there are some CSI-RS resources that are necessary to be transmitted for the legacy UEs, and the list of CSI-RS resources can be adapted to be the same as those need by the legacy UEs. In this case, by determining the CSI-RSs on the list to be available during the non-active period of the cell DTX cycle and those not on the list to be not available during the non-active period of the cell DTX cycle, no extra network transmissions will be increased and the UE throughput and performance can be maintained due to the available CSI-RSs during the non-active period of the cell DTX cycle, for example, UEs can always perform the measurement for downlink channel quality based on the updated CSI-RSs, which facilitates in turn to the adjustment of the network device.

According to some other embodiments, the step S320, determining whether there are one or more CSI-RSs available during the non-active period of the cell DTX cycle of the network device based on the result of the detection may include determining that CSI-RSs on the list of CSI-RS resources are not available during the non-active period of the cell DTX cycle, and determining that the CSI-RSs not on the list of CSI-RS resources are available during the non-active period of the cell DTX cycle.

Continuing to refer to FIG. 3, step S320, determining whether there are one or more CSI-RSs available during the non-active period of the cell DTX cycle of the network device based on the result of the detection may include: step S323, in response to detecting that no list of CSI-RS resources is configured by the network device for the non-active period of the cell DTX cycle of the network device, determining that all CSI-RSs are available during the non-active period of the cell DTX cycle; step S324, in response to detecting that no list of CSI-RS resources is configured by the network device for the non-active period of the cell DTX cycle of the network device, determining that no CSI-RS is available during the non-active period of the cell DTX cycle; or step S325, in response to detecting that no list of CSI-RS resources is configured by the network device for the non-active period of the cell DTX cycle of the network device, determining whether there are one or more CSI-RSs available during the non-active period of the cell DTX cycle of the network device based on whether cell DTX cycles are configured to align with CSI-RS cycles.

According to some embodiments, when UE does not receive a list of CSI-RS resources configured by the network device for the non-active period of the cell DTX cycle, by determining all CSI-RSs being available during the non-active period of the cell DTX cycle, the UE can monitor the downlink channel changes for reporting to the network device, thereby increasing the UE throughput and performance.

According to some other embodiments, when UE does not receive a list of CSI-RS resources configured by the network device for the non-active period of the cell DTX cycle, by determining no CSI-RS being available during the non-active period of the cell DTX cycle, the transmission from network device can be reduced, thereby reducing the energy consumption.

According to some other embodiments, when UE does not receive a list of CSI-RS resources configured by the network device for the non-active period of the cell DTX cycle, the UE can determine the availability of the CSI-RSs based on the whether cell DTX cycles are configured to align with CSI-RS resource cycles.

In the present disclosure, the alignment of the cell DTX cycles with the CSI-RS cycles can be determined based the starting offsets of each cell DTX cycle and each CSI-RS cycle. For example, when the cell DTX cycle is an integer multiple of CSI-RS cycle and the starting offset of the cell DTX cycle is aligned with that of the CSI-RS cycle, the cell DTX cycles can be determined as being aligned with the CSI-RS cycles. For example, when the CSI-RS cycle is an integer multiple of the cell DTX cycle and the starting offset of the cell DTX cycle is aligned with that of the CSI-RS cycle, the cell DTX cycles can be also determined as being aligned with the CSI-RS cycles.

In this case, S325, determining whether there are one or more CSI-RSs available during the non-active period of the cell DTX cycle of the network device based on whether the cell DTX cycles are configured to align with CSI-RS cycles may include: if the cell DTX cycles are configured to align with the CSI-RS cycles, determining that no CSI-RS is available during the non-active period of the cell DTX cycle; and if the cell DTX cycles are configured not to align with the CSI-RS cycles, determining that all CSI-RSs are available during the non-active period of the cell DTX cycle.

By determining the availability of the CSI-RSs based on the alignment of the cell DTX cycles and the CSI-RS cycles, the network devices are not necessary to send all CSI-RSs in each cell DTX cycle, reducing the energy consumption on the network device.

As discussed above, the CSI-RS is an important parameter for measurement downlink channel changes by the UE. Therefore, the availability of the CSI-RSs will affect the UE measurement requirement, such as measurement requirement for CSI-RS based L1-RSRP reporting, measurement requirement for CSI-RS based beam failure detection, etc.

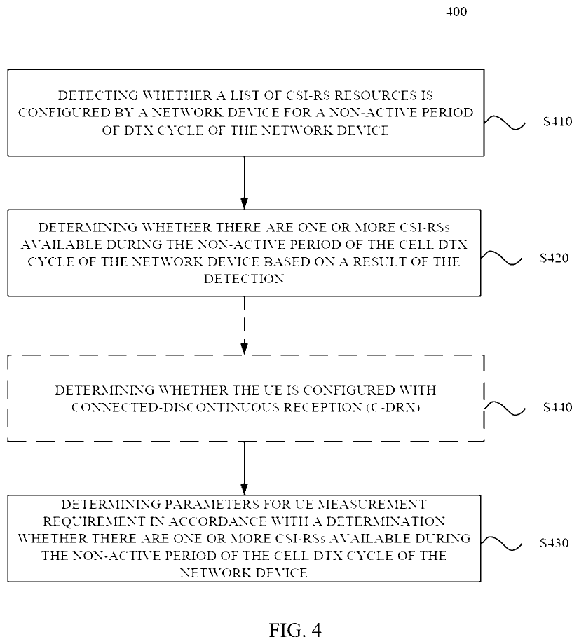

To redefine the UE measurement requirement based on the UE assumption on whether the CSI-RSs for a certain purpose (for example, T/F tracking, CSI computation, L1-RSRP, L1-SINR, mobility, fast Scell activation tracking, or a combination thereof) is available or not, the present application further provides a method for a UE which is illustrated in FIG. 4.

Referring to FIG. 4, in some embodiments, the method 400 for the UE may include the following steps: S410-S420, which are the same as or similar to steps S210-S220, and step S430, determining parameters for UE measurement requirement in accordance with a determination whether there are one or more CSI-RSs available during the non-active period of the cell DTX cycle of the network device.

By determining the parameters for UE measurement requirement based on the availability of the CSI-RSs during the non-active period of the cell DTX cycle, the measurement parameters can be adjusted in real-time and the accuracy of measurement can be improved.

Continuing to refer to FIG. 4, the method 400 may further include step S440, determining whether the UE is configured with Connected-Discontinuous Reception (C-DRX), and step S430, determining parameters for UE measurement requirement in accordance with a determination whether there are one or more CSI-RSs available during the non-active period of the cell DTX cycle of the network device may include: determining the parameters for the UE measurement requirement in accordance with a determination whether there are one or more CSI-RSs available during the non-active period of the cell DTX cycle and a determination whether the UE is configured with C-DRX.

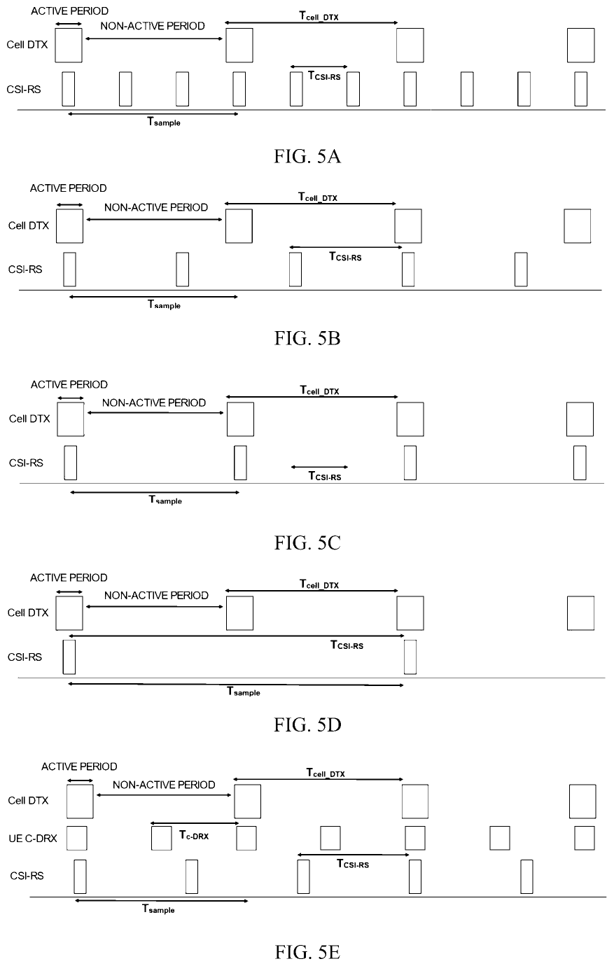

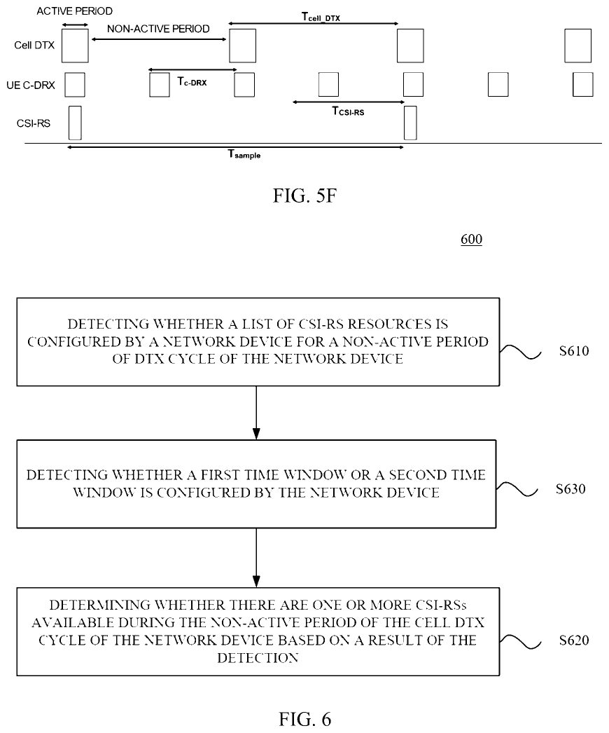

Various embodiments of determining the parameters for the UE measurement will be described in detail below with reference to FIGS. 5A to 5F.

According to some embodiments, determining the parameters for the UE measurement requirement in accordance with a determination whether there are one or more CSI-RSs available during the non-active period of the cell DTX cycle and a determination whether the UE is configured with C-DRX may include: in accordance with a determination that the UE is not configured with C-DRX: in accordance with a determination that there are one or more CSI-RSs available during the non-active period of the cell DTX cycle, determining a sample interval for the corresponding UE measurement requirement as a maximum between a CSI-RS cycle and the cell DTX cycle; and in accordance with a determination that there is no CSI-RS available during the non-active period of the cell DTX cycle, determining the sample interval for the corresponding UE measurement requirement as least common multiple of the CSI-RS cycle and the cell DTX cycle; and in accordance with a determination that the UE is configured with C-DRX: in accordance with a determination that there are one or more CSI-RSs available during the non-active period of the cell DTX cycle: determining the sample interval for the corresponding UE measurement requirement as a maximum among the CSI-RS cycle, the cell DTX cycle and a UE C-DRX cycle; and determining a relaxation factor based on the UE C-DRX cycle; and in accordance with a determination that there is no CSI-RS available during the non-active period of the cell DTX cycle, determining the sample interval for the corresponding UE measurement requirement as least common multiple of the CSI-RS cycle, the cell DTX cycle, and the UE C-DRX cycle.

In the case that the UE is configured with a C-DRX cycle, considering the UE C-DRX cycle when determining the sample interval, the accuracy of measurement can be improved.

FIGS. 5A-5B respectively illustrates an exemplary diagram showing the sample interval determined for the UE measurement requirement in accordance with a determination that the UE is not configured with C-DRX and in accordance with a determination that there are one or more CSI-RSs available during the non-active period of the cell DTX cycle. As shown in FIGS. 5A-5B, assuming that the CSI-RSs are available during the non-active period of the cell DTX cycle and the cell DTX cycle is greater than the CSI-RS cycle, then the sample interval for corresponding UE measurement requirement can be determined as a maximum between a CSI-RS cycle T_{CSI-RS} and the cell DTX cycle T_{cell_DTX}, i.e., Tₛₐₘₚₗₑ=T_{cell_DTX}.

FIGS. 5C-5D respectively illustrates an exemplary diagram showing the sample interval determined for the UE measurement requirement in accordance with a determination that the UE is not configured with C-DRX and in accordance with a determination that there is no CSI-RS available during the non-active period of the cell DTX cycle. As shown in FIGS. 5C-5D, assuming that the CSI-RSs are not available during the non-active period of the cell DTX cycle and the cell DTX cycles are aligned with the CSI-RS cycles (in these examples, the CSI-RS cycle is the same as the cell DTX cycle or is twice the cell DTX cycle, respectively), then the sample interval for corresponding UE measurement requirement can also be determined as the maximum of the CSI-RS cycle T_{CSI-RS} and the cell DTX cycle T_{cell_DTX}, i.e., Tₛₐₘₚₗₑ=T_{cell_DTX}=T_{CSI-RS} in FIG. 5C and Tₛₐₘₚₗₑ=T_{CSI-RS} in FIG. 5D.

FIG. 5E illustrates an exemplary diagram showing the sample interval determined for the UE measurement requirement in accordance with a determination that the UE is configured with C-DRX and in accordance with a determination that there are one or more CSI-RSs available during the non-active period of the cell DTX cycle. As shown in FIG. 5E, assuming that the CSI-RSs are available during the non-active period of the cell DTX cycle and the cell DTX cycle is greater than both the CSI-RS cycle and the UE C-DRX cycle, then the sample interval for corresponding UE measurement requirement can be determined as a maximum among the CSI-RS cycle T_{CSI-RS}, the cell DTX cycle T_{cell_DTX} and a UE C-DRX cycle T_{UE C-DRX}, i.e., Tₛₐₘₚₗₑ=T_{cell_DTX}.

FIG. 5F illustrates an exemplary diagram showing the sample interval determined for the UE measurement requirement in accordance with a determination that the UE is configured with C-DRX and in accordance with a determination that there is no CSI-RS available during the non-active period of the cell DTX cycle. As shown in FIG. 5F, assuming that the CSI-RSs are not available during the non-active period of the cell DTX cycle and the CSI-RS cycle is twice the cell DTX cycle and three time the UE C-DRX cycle, then the sample interval for corresponding UE measurement requirement can be determined as the least common multiple of the CSI-RS cycle T_{CSI-RS}, the cell DTX cycle T_{cell_DTX}, and the UE C-DRX cycle T_{UE C-DRX}, i.e., Tₛₐₘₚₗₑ=T_{CSI-RS}.

According to some embodiments of the present application, the method 400 may further include determining whether the UE C-DRX cycle is greater than a predetermined threshold, and wherein determining a relaxation factor based on the UE C-DRC cycle may include: in accordance with a determination that the UE C-DRX cycle is greater than the predetermined threshold, determining the relaxation factor as 1; and in accordance with a determination that the UE C-DRX cycle is not greater than the predetermined threshold, determining the relaxation factor being larger than 1.

According to some embodiments of the present application, the predetermined threshold can be any suitable values according to the requirements for UE, such as 100 ms, 200 ms, 320 ms, etc.

According to some other embodiments of the present application, when the relaxation factor is determined as being larger than 1, any suitable values lager than 1 can be selected according to the requirements for UE, such as 1.5, 2, etc.

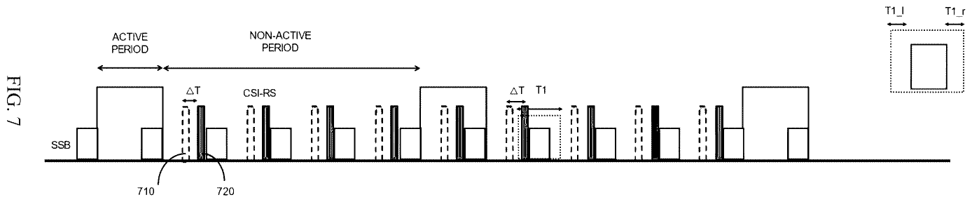

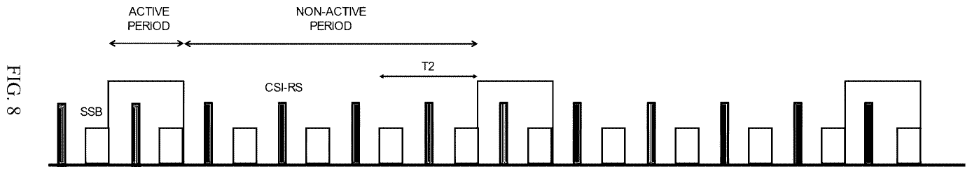

FIG. 6 illustrates another flowchart of an exemplary method for a user equipment in accordance with some embodiments of the present disclosure. As shown in FIG. 6, the method 600 may include the following steps: S610-S620 which are the same as or similar to steps S210-S220; and step S630, detecting whether a first time window or a second time window is configured by the network device, wherein the first time window is located in the non-active period of the cell DTX cycle, and the starting offset and ending offset of the first time window are respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle; and wherein step S620 determining whether there are one or more CSI-RSs available during the non-active period of the cell DTX cycle of the network device based on a result of the detection may include: in response to detecting that a list of CSI-RS resources is configured by the network device for the non-active period of the cell DTX cycle of the network device: in response to detecting that the first time window or the second time window is configured by the network device: determining that the CSI-RSs on the list of CSI-RS resources are available during the first time window or the second time window and determining that the CSI-RSs not on the list of CSI-RS resources are not available during the non-active period of the cell DTX cycle.

According to some embodiments, in the scenario where the network device offloads all the natural energy saving (NES) incapable connected UEs to other cells while maintaining SSB/CORESET 0/SIBs/Paging transmission for UEs in IDLE/INACTIVE mode in the current cell, by configuring a first time window after and before SSB/CORESET 0/SIBs/Paging PDCCH/Paging PDSCH, the above mentioned signals that would be necessarily transmitted may fall within the first time window. In this case, by determining the CSI-RSs on the list to be available during the first time window and those not on the list to be not available during the non-active period of the cell DTX cycle, transmission can only occur during the first time window and it is possible for the network device not to frequently wake up from the sleep mode for the extra transmissions. Meanwhile, the UE throughput and performance can be maintained due to the available CSI-RSs during the non-active period of the cell DTX cycle.

According to some other embodiments, step S620 determining whether there are one or more CSI-RSs available during the non-active period of the cell DTX cycle of the network device based on a result of the detection may include: in response to detecting that configured by the network device for the non-active period of the cell DTX cycle of the network device: in response to detecting that the first time window or the second time window is configured by the network device: determining that the CSI-RSs not on the list of CSI-RS resources are available during the first time window or the second time window and determining that the CSI-RSs on the list of CSI-RS resources are not available during the non-active period of the cell DTX cycle.

According to some embodiments, the first time window may be configured by at least one of: a duration of the first time window; and two parameters respectively indicating the starting offset and ending offset of the first time window. FIG. 7 illustrates an exemplary diagram showing how the first time window is configured. As shown in FIG. 7, the duration of the first time window is T1, and the starting offset T1_1 and ending offset T1_r are respectively located on the left side and right side of the SSB/CORESET 0/SIBs/Paging PDCCH/Paging PDSCH.

It should be noted that the above three parameters T1, T1_1 and T1_r are shown in FIG. 7 for the purpose of better illustration rather limitation, the first time window can also be configured by only a duration of the first time window T1, or only a combination of starting offset T1_1 and ending offset T1_r.

According to some embodiments of the present application, the duration of the first time window may be signal/channel specific. For example, the duration T1 can be configured different for SSB and Paging transmission.

To further reduce the number of transmissions of the network device during the non-active period of the cell DTX cycle and save the energy, the method 600 may further include: detecting whether a time offset for the CSI-RSs on the list of CSI-RS resources is configured by the network device, wherein the time offset indicates a shift offset for the CSI-RSs such that the locations of the CSI-RSs are closer to those of Synchronization Signal Block (SSB)/CORESET 0/System Information Block (SIB)/Paging Physical Downlink Control Channel (PDCCH)/Paging Physical Downlink Share Channel (PDSCH); and in response to detecting that a time offset for the CSI-RSs on the list of CSI-RS resources is configured by the network device, shifting the CSI-RSs on the list of CSI-RS resources by the time offset.

Continuing to refer to FIG. 7, the grey columns 710 in dashed lines refer to the previous locations of the CSI-RSs and the grey columns 720 in solid lines refer to the shifted locations of the CSI-RSs. After shifting the CSI-RSs by an amount of time offset AT, the CSI-RSs can be closer to the SSB/CORESET 0/SIB/Paging PDCCH/Paging PDSCH. In a specific example, the CSI-RSs can be shifted just before or after the SSB/CORESET 0/SIB/Paging PDCCH/Paging PDSCH. In this way, it is possible for the network device not to frequently wake up from the sleep mode for the extra transmissions, thereby reducing the energy consumption.

According to some other embodiments, in the scenario for an SSB-less cell where SSB can be even stopped for extreme energy saving, such that only NES capable UEs in CONNECTED mode can access the cell for data transmission if necessary, it is possible that the above mentioned signals, which should be transmitted for legacy UEs or for SSB/Paging, will no longer be necessary and only the active period of the cell DTX cycle will be transmitted. FIG. 8 illustrates an exemplary diagram showing how the second time window is configured. As shown in FIG. 8, the second time window can be configured with a duration of T2 just before the active period of the cell DTX cycle. With such configuration, the UE can determine that the CSI-RSs on the list to be available during the second time window and those not on the list to be not available during the non-active period of the cell DTX cycle, thereby facilitating to reducing the energy consumption as described above.

According to some embodiments of the present application, determining whether there are one or more CSI-RSs available during the non-active period of the cell DTX cycle of the network device based on a result of the detection may further include: in response to detecting that no list of CSI-RS resources is configured by the network device for the non-active period of the cell DTX cycle of the network device: in response to detecting that the first time window or the second window is configured by the network device, determining that all CSI-RSs falling within the first time window or the second time window are available during the non-active period of the cell DTX cycle; and in response to detecting that no first time window and second time window is configured by the network device: determining that all CSI-RSs are available during the non-active period of the cell DTX cycle; determining that no CSI-RS is available during the non-active period of the cell DTX cycle; or determining whether there are one or more CSI-RSs available during the non-active period of the cell DTX cycle of the network device based on whether the cell DTX cycles are configured to align with CSI-RS cycles.

According to some embodiments, when UE does not receive a list of CSI-RS resources configured by the network device for the non-active period of the cell DTX cycle but a first time window or a second time window is configured, by determining all CSI-RSs falling within the first window or second window being available during the non-active period of the cell DTX cycle, the number of transmissions by network device can be reduced as much as possible due to the suitable configurations for the locations of CSI-RSs and locations of the SSB/Paging transmission or active periods of the cell DTX cycle.

According to some other embodiments, when UE receives neither a list of CSI-RS resources configured by the network device for the non-active period of the cell DTX cycle, nor a first time window or second time window, by determining all CSI-RSs being available during the non-active period of the cell DTX cycle, the UE can monitor the downlink channel changes for reporting to the network device, thereby increasing the UE throughput and performance.

According to some other embodiments, when UE receives neither a list of CSI-RS resources configured by the network device for the non-active period of the cell DTX cycle, nor a first time window or second time window, by determining no CSI-RS being available during the non-active period of the cell DTX cycle, the transmission from network device can be reduced, thereby reducing the energy consumption.

According to some other embodiments, when UE receives neither a list of CSI-RS resources configured by the network device for the non-active period of the cell DTX cycle, nor a first time window or second time window, the UE can determine the availability of the CSI-RSs based on the whether cell DTX cycles are configured to align with CSI-RS cycles.

As discussed above, in the present disclosure, the alignment of the cell DTX cycles with the CSI-RS cycles can be determined based the starting offsets of each cell DTX cycle and each CSI-RS cycle. For example, when the cell DTX cycle is an integer multiple of CSI-RS cycle and the starting offset of the cell DTX cycle is aligned with that of the CSI-RS cycle, the cell DTX cycles can be determined as being aligned with the CSI-RS cycles. In this case, determining whether there are one or more CSI-RSs available during the non-active period of the cell DTX cycle of the network device based on whether the cell DTX cycles are configured to align with CSI-RS cycles may include: if the cell DTX cycles are configured to align with the CSI-RS cycles, determining that no CSI-RS is available during the non-active period of the cell DTX cycle; and if the cell DTX cycles are configured not to align with the CSI-RS cycles, determining that all CSI-RSs are available during the non-active period of the cell DTX cycle.

By determining the availability of the CSI-RSs based on the alignment of the cell DTX cycles and the CSI-RS cycles, the network devices are not necessary to send all CSI-RSs in each cell DTX cycle, reducing the energy consumption on the network device.

Similarly, to redefine the UE measurement requirement based on the UE assumption on whether the CSI-RSs for a certain purpose (for example, T/F tracking, CSI computation, L1-RSRP, L1-SINR, mobility, fast Scell activation tracking, or a combination thereof) is available or not in the scenarios where UE detects whether the first time window or the second time window is configured, the method 600 may further include: determining parameters for UE measurement requirement in accordance with a determination whether there are one or more CSI-RSs available during the non-active period of the cell DTX cycle of the network device, which may include determining the parameters for the UE measurement requirement in accordance with a determination whether there are one or more CSI-RSs available during the non-active period of the cell DTX cycle and a determination whether the UE is configured with Connected-Discontinuous Reception (C-DRX).

By determining the parameters for UE measurement requirement based on the availability of the CSI-RSs during the non-active period of the cell DTX cycle, the measurement parameters can be adjusted in real-time and the accuracy of measurement can be improved.

According to some embodiments of the present application, determining the parameters for the UE measurement requirement in accordance with a determination whether there are one or more CSI-RSs available during the non-active period of the cell DTX cycle and a determination whether the UE is configured with C-DRX may include: in response to detecting that the first time window is configured by the network device: in accordance with a determination that the UE is not configured with C-DRX: in accordance with a determination that there are one or more CSI-RSs available during the non-active period of the cell DTX cycle, determining a sample interval for the corresponding UE measurement requirement as a maximum between a portion of a CSI-RS cycle that falls within the first time window and the cell DTX cycle; and in accordance with a determination that there is no CSI-RS available during the non-active period of the cell DTX cycle, determining the sample interval for the corresponding UE measurement requirement as least common multiple of the CSI-RS cycle and the cell DTX cycle; and in accordance with a determination that the UE is configured with C-DRX; in accordance with a determination that there are one or more CSI-RSs available during the non-active period of the cell DTX cycle: determining the sample interval for the corresponding UE measurement requirement as a maximum among the portion of the CSI-RS cycle that falls within the first time window, the cell DTX cycle and a UE C-DRX cycle; and determining a relaxation factor based on the UE C-DRX cycle; and in accordance with a determination that there is no CSI-RS available during the non-active period of the cell DTX cycle, determining the sample interval for the corresponding UE measurement requirement as least common multiple of the CSI-RS cycle, the cell DTX cycle, and the UE C-DRX cycle.

According to some other embodiments of the present application, determining the parameters for the UE measurement requirement in accordance with a determination whether there are one or more CSI-RSs available during the non-active period of the cell DTX cycle and a determination whether the UE is configured with C-DRX may include: in response to detecting that the second time window is configured by the network device: in accordance with a determination that the UE is not configured with C-DRX: in accordance with a determination that there are one or more CSI-RSs available during the non-active period of the cell DTX cycle, determining a sample interval for the corresponding UE measurement requirement as the cell DTX cycle; and in accordance with a determination that there is no CSI-RS available during the non-active period of the cell DTX cycle, determining the sample interval for the corresponding UE measurement requirement as least common multiple of the CSI-RS cycle and the cell DTX cycle; and in accordance with a determination that the UE is configured with C-DRX; in accordance with a determination that there are one or more CSI-RSs available during the non-active period of the cell DTX cycle: determining the sample interval for the corresponding UE measurement requirement as a maximum between the cell DTX cycle and a UE C-DRX cycle; and determining a relaxation factor based on the UE C-DRC cycle; and in accordance with a determination that there is no CSI-RS available during the non-active period of the cell DTX cycle, determining the sample interval for the corresponding UE measurement requirement as least common multiple of the CSI-RS cycle, the cell DTX cycle, and the UE C-DRX cycle.

In the case that the UE is configured with a C-DRX cycle, considering the UE C-DRX cycle when determining the sample interval, the accuracy of measurement can be improved.

According to some embodiments of the present application, the method 600 may further include determining whether the UE C-DRX cycle is greater than a predetermined threshold, and wherein determining a relaxation factor based on the UE C-DRC cycle may include: in accordance with a determination that the UE C-DRX cycle is greater than the predetermined threshold, determining the relaxation factor as 1; and in accordance with a determination that the UE C-DRX cycle is not greater than the predetermined threshold, determining the relaxation factor being larger than 1.

According to some embodiments of the present application, the predetermined threshold can be any suitable values according to the requirements for UE, such as 100 ms, 200 ms, 320 ms, etc.

According to some other embodiments of the present application, when the relaxation factor is determined as being larger than 1, any suitable values lager than 1 can be selected according to the requirements for UE, such as 1.5, 2, etc.

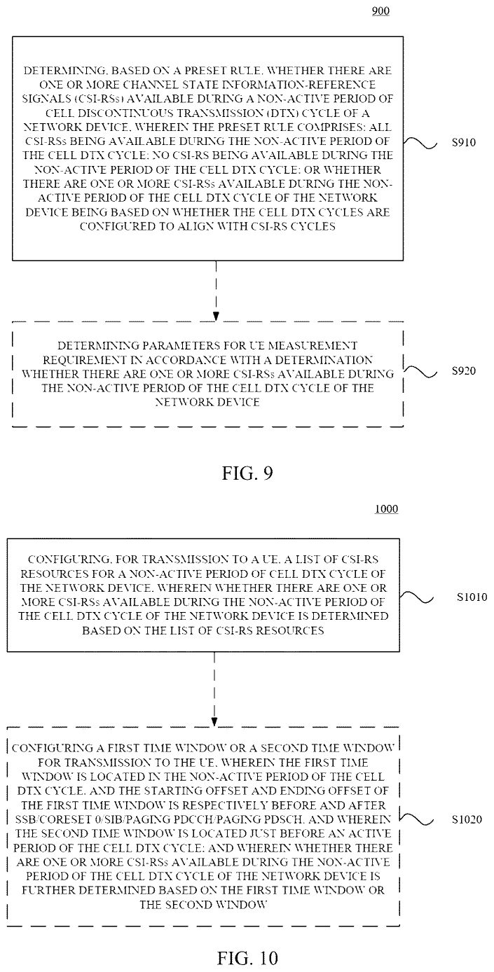

FIG. 9 illustrates a flowchart of another exemplary method for a user equipment in accordance with some embodiments of the present disclosure. The method illustrated in FIG. 9 may be also implemented by the UE 101 described with reference to FIG. 1.

Referring FIG. 9, in some embodiments, the method 900 for UE may include the following steps: S910, determining, based on a preset rule, whether there are one or more Channel State Information-Reference Signal (CSI-RS) resources available during a non-active period of cell discontinuous transmission (DTX) cycle of a network device, wherein the preset rule may include: all CSI-RSs being available during the non-active period of the cell DTX cycle; no CSI-RS being available during the non-active period of the cell DTX cycle; or whether there are one or more CSI-RSs available during the non-active period of the cell DTX cycle of the network device being based on whether the cell DTX cycles are configured to align with CSI-RS cycles.

According to some embodiments of the present disclosure, the method 900 may further include: step S920, determining parameters for UE measurement requirement in accordance with a determination whether there are one or more CSI-RSs available during the non-active period of the cell DTX cycle of the network device.

It will be appreciated that the steps S910-S920 shown in FIG. 9 may be similar to the above steps described with reference to FIGS x-x, therefore, elements, expressions, features etc. that have already been described above and its corresponding description are omitted herein for clarity.

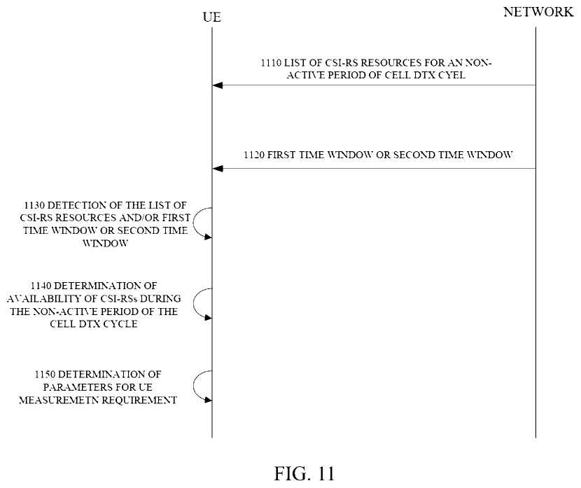

FIG. 10 illustrates a flowchart of an exemplary method 1000 for a network device in accordance with some embodiments of the present disclosure. The method 1000 illustrated in FIG. 10 may be implemented by the base station 150 described in FIG. 1. For example, the network device may be the network device of the base station 150.

In some embodiments, the method 1000 for a network device may include the following steps: S1010, configuring, for transmission to a user equipment (UE), a list of Channel State Information-Reference Signal (CSI-RS) resources for a non-active period of cell discontinuous transmission (DTX) cycle of the network device, wherein whether there are one or more CSI-RSs available during the non-active period of the cell DTX cycle of the network device is determined based on the list of CSI-RS resources.

According to some embodiments of the present disclosure, by configuring a list of CSI-RS resources for the non-active period of the cell DTX cycle for transmission to the UE, the UE can determine the availability of one or more CSI-RSs during the non-active period of the cell DTX cycle. As a result, the network device may utilize the existing signals for transmission of the CSI-RSs or transmit more important CSI-RSs for improving the performance of UE. Accordingly, the throughput and performance such as latency performance can be ensured, and it is not necessary for the network device to send the CSI-RS separately or send all CSI-RSs, thereby reducing the energy consumption.

According to some embodiments of the present disclosure, the method 1000 may further include: step S1020, configuring a first time window or a second time window for transmission to the UE, wherein the first time window is located in the non-active period of the cell DTX cycle, and the starting offset and ending offset of the first time window is respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle; and wherein whether there are one or more CSI-RSs available during the non-active period of the cell DTX cycle of the network device is further determined based on the first time window or the second window.

It will be appreciated that the steps in the method 1000 are similar to those in the method 200, 300, 400 and 600, therefore those elements, expressions, features etc. that have already been described with reference to FIGS. 2-4 and FIG. 6 and its corresponding description (about UE) are omitted herein for clarity.

FIG. 11 illustrates a flowchart of exemplary steps for determining availability of CSI-RSs during a non-active period of cell DTX cycle and UE measurement requirement in accordance with some embodiments of the present disclosure.

In FIG. 11, the steps of the method for UE and the method for network device to determine the availability of CSI-RSs during a non-active period of cell DTX cycle and redefine the corresponding UE measurement are shown.

At Step S1110, the network device may configure, for transmission to a user equipment (UE), a list of Channel State Information-Reference Signal (CSI-RS) resources for a non-active period of cell discontinuous transmission (DTX) cycle of the network device. Step S810 can be implemented according to the description with reference to step S1010.

At Step S1120, the network device may further configure a first time window or a second time window for transmission to the UE, wherein the first time window is located in the non-active period of the cell DTX cycle, and the starting offset and ending offset of the first time window is respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle. Step S820 can be implemented according to the description with reference to step S1020.

At Step S1130, the UE may detect whether the list of CSI-RS resources is configured by a network device for the non-active period of the cell discontinuous transmission (DTX) cycle of the network device. Step S1130 can be implemented according to the description with reference to step S210, step S310, step S410 and/or step S610.

At Step S1140, the UE may determine whether there are one or more CSI-RSs available during the non-active period of the cell DTX cycle of the network device based on a result of the detection. Step S1130 can be implemented according to the description with reference to step S220, step S320, step S420 and/or step S620.

At Step S1150, the UE may determine parameters for UE measurement requirement in accordance with a determination whether there are one or more CSI-RSs available during the non-active period of the cell DTX cycle of the network device. Step S1130 can be implemented according to the description with reference to step S430 and/or step S630.

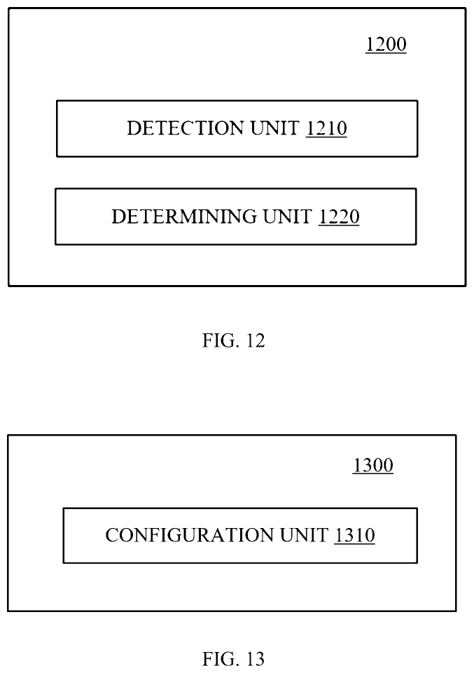

FIG. 12 illustrates an exemplary block diagram of an apparatus 1200 for a UE in accordance with some embodiments of the present disclosure. The apparatus 1200 illustrated in FIG. 12 may be used to implement the methods 200, 300, 400 and 600 illustrated in combination with FIGS. 2-4 and FIG. 6, respectively.

As illustrated in FIG. 12, the apparatus 1200 may include a detection unit 1210 and a determining unit 1220. The detection unit 1210 may be configured to detect whether a list of Channel State Information-Reference Signal (CSI-RS) resources is configured by a network device for a non-active period of cell discontinuous transmission (DTX) cycle of the network device. The determining unit 1220 may be configured to determine whether there are one or more CSI-RSs available during the non-active period of the cell DTX cycle of the network device based on a result of the detection.

According to some embodiments of the present disclosure, by detecting a list of CSI-RS resources configured by the network device and determining the availability of one or more CSI-RSs during the non-active period of the cell DTX cycle, it is possible for network to utilize the existing signals for transmission of the CSI-RSs or transmit more important CSI-RSs for improving the performance of UE. Accordingly, the throughput and performance such as latency performance can be ensured, and it is not necessary for the network device to send the CSI-RS separately or send all CSI-RSs, thereby reducing the energy consumption.

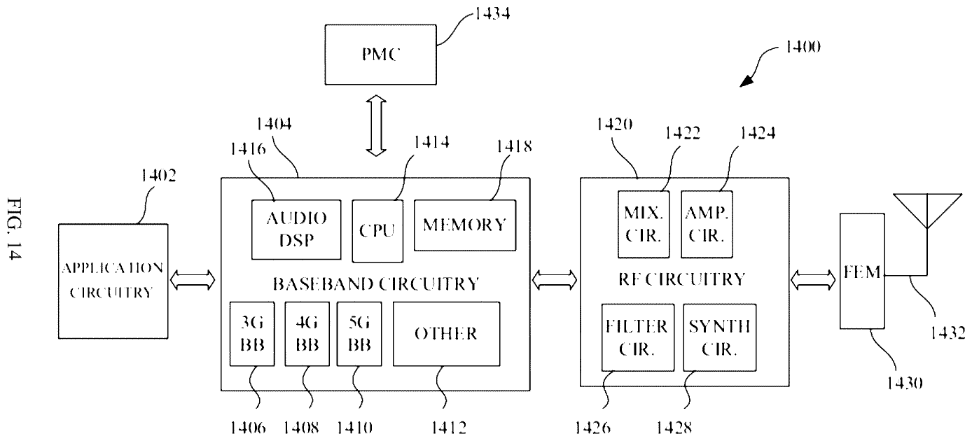

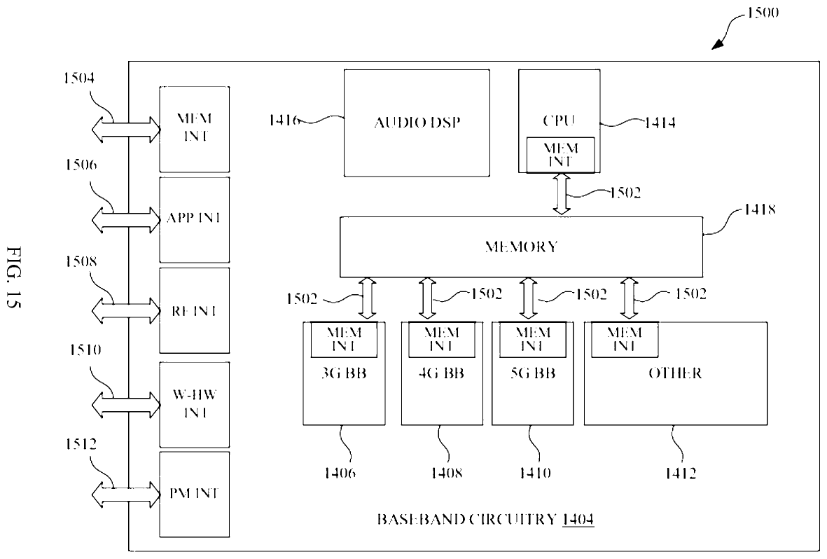

FIG. 13 illustrates an exemplary block diagram of an apparatus 1300 for a network device in accordance with some embodiments of the present disclosure. The apparatus 1300 illustrated in FIG. 13 may be used to implement the method 1000 as illustrated in combination with FIG. 10.

As illustrated in FIG. 13, the apparatus 1300 may include a configuration unit 1310. The configuration unit 1310 may be configured to configure a first time window or a second time window for transmission to the UE, wherein the first time window is located in the non-active period of the cell DTX cycle, and the starting offset and ending offset of the first time window is respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle; and wherein whether there are one or more CSI-RSs available during the non-active period of the cell DTX cycle of the network device is further determined based on the first time window or the second window.

According to some embodiments of the present disclosure, by configuring a list of CSI-RS resources for the non-active period of the cell DTX cycle for transmission to the UE, the UE can determine the availability of one or more CSI-RSs during the non-active period of the cell DTX cycle. As a result, the network device may utilize the existing signals for transmission of the CSI-RSs or transmit more important CSI-RSs for improving the performance of UE. Accordingly, the throughput and performance such as latency performance can be ensured, and it is not necessary for the network device to send the CSI-RS separately or send all CSI-RSs, thereby reducing the energy consumption.

FIG. 14 illustrates example components of a device 1400 in accordance with some embodiments of the present disclosure. In some embodiments, the device 1400 may include application circuitry 1402, baseband circuitry 1404, Radio Frequency (RF) circuitry (shown as RF circuitry 1420), front-end module (FEM) circuitry (shown as FEM circuitry 1430), one or more antennas 1432, and power management circuitry (PMC) (shown as PMC 1434) coupled together at least as shown. The components of the illustrated device 1400 may be included in a UE or a RAN node. In some embodiments, the device 1400 may include fewer elements (e.g., a RAN node may not utilize application circuitry 1402, and instead include a processor/controller to process IP data received from an EPC). In some embodiments, the device 1400 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1402 may include one or more application processors. For example, the application circuitry 1402 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1400. In some embodiments, processors of application circuitry 1402 may process IP data packets received from an EPC.

The baseband circuitry 1404 may include circuitry such as, but not limited to, one or more single-core or multi-core processors. The baseband circuitry 1404 may include one or more baseband processors or control logic to process baseband signals received from a receive signal path of the RF circuitry 1420 and to generate baseband signals for a transmit signal path of the RF circuitry 1420. The baseband circuitry 1404 may interface with the application circuitry 1402 for generation and processing of the baseband signals and for controlling operations of the RF circuitry 1420. For example, in some embodiments, the baseband circuitry 1404 may include a third generation (3G) baseband processor (3G baseband processor 1406), a fourth generation (4G) baseband processor (4G baseband processor 1408), a fifth generation (5G) baseband processor (5G baseband processor 1410), or other baseband processor(s) 1412 for other existing generations, generations in development or to be developed in the future (e.g., second generation (2G), sixth generation (6G), etc.). The baseband circuitry 1404 (e.g., one or more of baseband processors) may handle various radio control functions that enable communication with one or more radio networks via the RF circuitry 1420. In other embodiments, some or all of the functionality of the illustrated baseband processors may be included in modules stored in the memory 1418 and executed via a Central Processing ETnit (CPET 1414). The radio control functions may include, but are not limited to, signal modulation/demodulation, encoding/decoding, radio frequency shifting, etc. In some embodiments, modulation/demodulation circuitry of the baseband circuitry 1404 may include Fast-Fourier Transform (FFT), precoding, or constellation mapping/demapping functionality. In some embodiments, encoding/decoding circuitry of the baseband circuitry 1404 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1404 may include a digital signal processor (DSP), such as one or more audio DSP(s) 1416. The one or more audio DSP(s) 1416 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1404 and the application circuitry 1402 may be implemented together such as, for example, on a system on a chip (SOC).

In some embodiments, the baseband circuitry 1404 may provide for communication compatible with one or more radio technologies. For example, in some embodiments, the baseband circuitry 1404 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1404 is configured to support radio communications of more than one wireless protocol may be referred to as multi-mode baseband circuitry.

The RF circuitry 1420 may enable communication with wireless networks using modulated electromagnetic radiation through a non-solid medium. In various embodiments, the RF circuitry 1420 may include switches, filters, amplifiers, etc. to facilitate the communication with the wireless network. The RF circuitry 1420 may include a receive signal path which may include circuitry to down-convert RF signals received from the FEM circuitry 1430 and provide baseband signals to the baseband circuitry 1404. The RF circuitry 1420 may also include a transmit signal path which may include circuitry to up-convert baseband signals provided by the baseband circuitry 1404 and provide RF output signals to the FEM circuitry 1430 for transmission. In some embodiments, the receive signal path of the RF circuitry 1420 may include mixer circuitry 1422, amplifier circuitry 1424 and filter circuitry 1426. In some embodiments, the transmit signal path of the RF circuitry 1420 may include filter circuitry 1426 and mixer circuitry 1422. The RF circuitry 1420 may also include synthesizer circuitry 1428 for synthesizing a frequency for use by the mixer circuitry 1422 of the receive signal path and the transmit signal path. In some embodiments, the mixer circuitry 1422 of the receive signal path may be configured to down-convert RF signals received from the FEM circuitry 1430 based on the synthesized frequency provided by synthesizer circuitry 1428. The amplifier circuitry 1424 may be configured to amplify the down-converted signals and the filter circuitry 1426 may be a low-pass filter (LPF) or band-pass filter (BPF) configured to remove unwanted signals from the down-converted signals to generate output baseband signals. Output baseband signals may be provided to the baseband circuitry 1404 for further processing. In some embodiments, the output baseband signals may be zero-frequency baseband signals, although this is not a requirement. In some embodiments, the mixer circuitry 1422 of the receive signal path may comprise passive mixers, although the scope of the embodiments is not limited in this respect.

In some embodiments, the mixer circuitry 1422 of the transmit signal path may be configured to up-convert input baseband signals based on the synthesized frequency provided by the synthesizer circuitry 1428 to generate RF output signals for the FEM circuitry 1430. The baseband signals may be provided by the baseband circuitry 1404 and may be filtered by the filter circuitry 1426.

In some embodiments, the mixer circuitry 1422 of the receive signal path and the mixer circuitry 1422 of the transmit signal path may include two or more mixers and may be arranged for quadrature downconversion and upconversion, respectively. In some embodiments, the mixer circuitry 1422 of the receive signal path and the mixer circuitry 1422 of the transmit signal path may include two or more mixers and may be arranged for image rejection (e.g., Hartley image rejection). In some embodiments, the mixer circuitry 1422 of the receive signal path and the mixer circuitry 1422 may be arranged for direct downconversion and direct upconversion, respectively. In some embodiments, the mixer circuitry 1422 of the receive signal path and the mixer circuitry 1422 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1420 may include analog-to-digital converter (ADC) and digital-to-analog converter (DAC) circuitry and the baseband circuitry 1404 may include a digital baseband interface to communicate with the RF circuitry 1420.

In some dual-mode embodiments, a separate radio IC circuitry may be provided for processing signals for each spectrum, although the scope of the embodiments is not limited in this respect.

In some embodiments, the synthesizer circuitry 1428 may be a fractional-N synthesizer or a fractional N/N+1 synthesizer, although the scope of the embodiments is not limited in this respect as other types of frequency synthesizers may be suitable. For example, synthesizer circuitry 1428 may be a delta-sigma synthesizer, a frequency multiplier, or a synthesizer comprising a phase-locked loop with a frequency divider.

The synthesizer circuitry 1428 may be configured to synthesize an output frequency for use by the mixer circuitry 1422 of the RF circuitry 1420 based on a frequency input and a divider control input. In some embodiments, the synthesizer circuitry 1428 may be a fractional N/N+1 synthesizer.

In some embodiments, frequency input may be provided by a voltage controlled oscillator (VCO), although that is not a requirement. Divider control input may be provided by either the baseband circuitry 1404 or the application circuitry 1402 (such as an applications processor) depending on the desired output frequency. In some embodiments, a divider control input (e.g., N) may be determined from a look-up table based on a channel indicated by the application circuitry 1402.

Synthesizer circuitry 1428 of the RF circuitry 1420 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1428 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1420 may include an IQ/polar converter.

The FEM circuitry 1430 may include a receive signal path which may include circuitry configured to operate on RF signals received from one or more antennas 1432, amplify the received signals and provide the amplified versions of the received signals to the RF circuitry 1420 for further processing. The FEM circuitry 1430 may also include a transmit signal path which may include circuitry configured to amplify signals for transmission provided by the RF circuitry 1420 for transmission by one or more of the one or more antennas 1432. In various embodiments, the amplification through the transmit or receive signal paths may be done solely in the RF circuitry 1420, solely in the FEM circuitry 1430, or in both the RF circuitry 1420 and the FEM circuitry 1430.

In some embodiments, the FEM circuitry 1430 may include a TX/RX switch to switch between transmit mode and receive mode operation. The FEM circuitry 1430 may include a receive signal path and a transmit signal path. The receive signal path of the FEM circuitry 1430 may include an LNA to amplify received RF signals and provide the amplified received RF signals as an output (e.g., to the RF circuitry 1420). The transmit signal path of the FEM circuitry 1430 may include a power amplifier (PA) to amplify input RF signals (e.g., provided by the RF circuitry 1420), and one or more filters to generate RF signals for subsequent transmission (e.g., by one or more of the one or more antennas 1432).

In some embodiments, the PMC 1434 may manage power provided to the baseband circuitry 1404. In particular, the PMC 1434 may control power-source selection, voltage scaling, battery charging, or DC-to-DC conversion. The PMC 1434 may often be included when the device 1400 is capable of being powered by a battery, for example, when the device 1400 is included in a EGE. The PMC 1434 may increase the power conversion efficiency while providing desirable implementation size and heat dissipation characteristics.

FIG. 14 shows the PMC 1434 coupled only with the baseband circuitry 1404. However, in other embodiments, the PMC 1434 may be additionally or alternatively coupled with, and perform similar power management operations for, other components such as, but not limited to, the application circuitry 1402, the RF circuitry 1420, or the FEM circuitry 1430.

In some embodiments, the PMC 1434 may control, or otherwise be part of, various power saving mechanisms of the device 1400. For example, if the device 1400 is in an RRC Connected state, where it is still connected to the RAN node as it expects to receive traffic shortly, then it may enter a state known as Discontinuous Reception Mode (DRX) after a period of inactivity. During this state, the device 1400 may power down for brief intervals of time and thus save power.

If there is no data traffic activity for an extended period of time, then the device 1400 may transition off to an RRC Idle state, where it disconnects from the network and does not perform operations such as channel quality feedback, handover, etc. The device 1400 goes into a very low power state and it performs paging where again it periodically wakes up to listen to the network and then powers down again. The device 1400 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1402 and processors of the baseband circuitry 1404 may be used to execute elements of one or more instances of a protocol stack. For example, processors of the baseband circuitry 1404, alone or in combination, may be used to execute Layer 3, Layer 2,or Layer 1 functionality, while processors of the application circuitry 1402 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

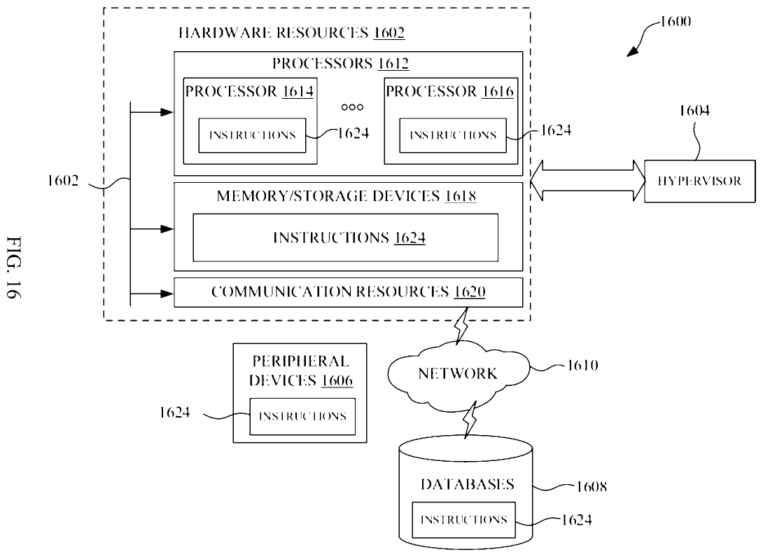

FIG. 15 illustrates example interfaces 1500 of baseband circuitry in accordance with some embodiments. As discussed above, the baseband circuitry 1404 of FIG. 14 may comprise 3G baseband processor 1406, 4G baseband processor 1408, 5baseband processor 1410, other baseband processor(s) 1412, CPU 1414, and a memory 1418 utilized by said processors. As illustrated, each of the processors may include a respective memory interface 1502 to send/receive data to/from the memory 1418.

The baseband circuitry 1404 may further include one or more interfaces to communicatively couple to other circuitries/devices, such as a memory interface 1504 (e.g., an interface to send/receive data to/from memory external to the baseband circuitry 1404), an application circuitry interface 1506 (e.g., an interface to send/receive data to/from the application circuitry 1402 of FIG. AA), an RF circuitry interface 1508 (e.g., an interface to send/receive data to/from RF circuitry 1420 of FIG. AA), a wireless hardware connectivity interface 1510 (e.g., an interface to send/receive data to/from Near Field Communication (NFC) components, Bluetooth® components (e.g., Bluetooth® Low Energy), Wi-Fi® components, and other communication components), and a power management interface 1512 (e.g., an interface to send/receive power or control signals to/from the PMC 1434.

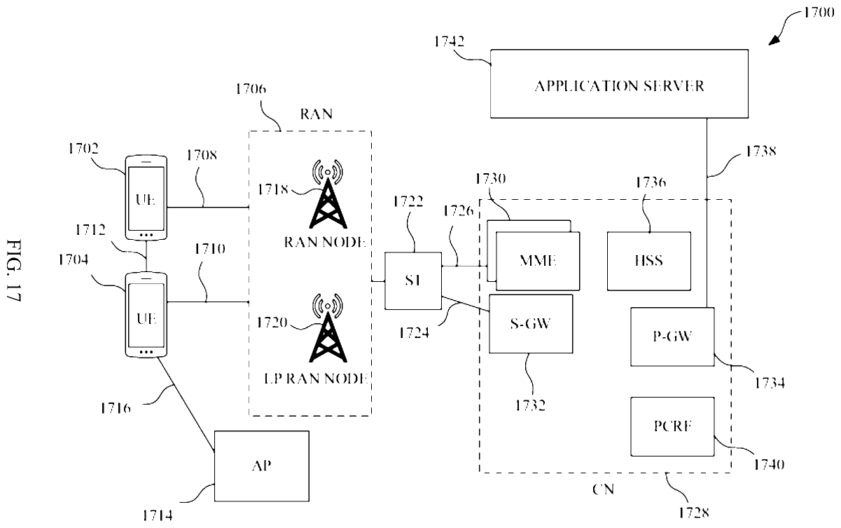

FIG. 16 is a block diagram illustrating components 1600, according to some example embodiments, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1602 including one or more processors 1612 (or processor cores), one or more memory/storage devices 1618, and one or more communication resources 1620, each of which may be communicatively coupled via a bus 1622. For embodiments where node virtualization (e.g., NFV) is utilized, a hypervisor 1604 may be executed to provide an execution environment for one or more network slices/sub-slices to utilize the hardware resources 1602.

The processors 1612 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1614 and a processor 1616.

The memory/storage devices 1618 may include main memory, disk storage, or any suitable combination thereof. The memory/storage devices 1618 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1620 may include interconnection or network interface components or other suitable devices to communicate with one or more peripheral devices 1606 or one or more databases 1608 via a network 1610. For example, the communication resources 1620 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1624 may comprise software, a program, an application, an applet, an app, or other executable code for causing at least any of the processors 1612 to perform any one or more of the methodologies discussed herein. The instructions 1624 may reside, completely or partially, within at least one of the processors 1612 (e.g., within the processor's cache memory), the memory/storage devices 1618, or any suitable combination thereof. Furthermore, any portion of the instructions 1624 may be transferred to the hardware resources 1602 from any combination of the peripheral devices 1606 or the databases 1608. Accordingly, the memory of the processors 1612, the memory/storage devices 1618, the peripheral devices 1606, and the databases 1608 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 17 illustrates an architecture of a system 1700 of a network in accordance with some embodiments. The system 1700 includes one or more user equipment (UE), shown in this example as a UE 1702 and a UE 1704. The UE 1702 and the UE 1704 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1702 and the UE 1704 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. The UE 1702 and the UE 1704 may be configured to connect, e.g., communicatively couple, with a radio access network (RAN), shown as RAN 1706. The RAN 1706 may be, for example, an Evolved ETniversal Mobile Telecommunications System (ETMTS) Terrestrial Radio Access Network (E-UTRAN), a NextGen RAN (NG RAN), or some other type of RAN. The UE 1702 and the UE 1704 utilize connection 1708 and connection 1710, respectively, each of which comprises a physical communications interface or layer (discussed in further detail below); in this example, the connection 1708 and the connection 1710 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1702 and the UE 1704 may further directly exchange communication data via a ProSe interface 1712. The ProSe interface 1712 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1704 is shown to be configured to access an access point (AP), shown as AP 1744, via connection 1716. The connection 1716 can comprise a local wireless connection, such as a connection consistent with any IEEE 802.14 protocol, wherein the AP 1714 would comprise a wireless fidelity (WiFi®) router. In this example, the AP 1714 may be connected to the Internet without connecting to the core network of the wireless system (described in further detail below). The RAN 1706 can include one or more access nodes that enable the connection 1708 and the connection 1710. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1406 may include one or more RAN nodes for providing macrocells, e.g., macro RAN node 1718, and one or more RAN nodes for providing femtocells or picocells (e.g., cells having smaller coverage areas, smaller user capacity, or higher bandwidth compared to macrocells), e.g., a low power (LP) RAN node such as LP RAN node 1720. Any of the macro RAN node 1718 and the LP RAN node 1720 can terminate the air interface protocol and can be the first point of contact for the UE 1702 and the UE 1704. In some embodiments, any of the macro RAN node 1718 and the LP RAN node 1720 can fulfill various logical functions for the RAN 1706 including, but not limited to, radio network controller (RNC) functions such as radio bearer management, uplink and downlink dynamic radio resource management and data packet scheduling, and mobility management.

In accordance with some embodiments, the EGE 1702 and the EGE 1704 can be configured to communicate using Orthogonal Frequency-Division Multiplexing (OFDM) communication signals with each other or with any of the macro RAN node 1718 and the LP RAN node 1720 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1718 and the LP RAN node 1720 to the UE 1702 and the UE 1704, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1702 and the UE 1704. The physical downlink control channel (PDCCH) may carry information about the transport format and resource allocations related to the PDSCH channel, among other things. It may also inform the UE 1702 and the UE 1704 about the transport format, resource allocation, and H-ARQ (Hybrid Automatic Repeat Request) information related to the uplink shared channel. Typically, downlink scheduling (assigning control and shared channel resource blocks to the UE 1704 within a cell) may be performed at any of the macro RAN node 1718 and the LP RAN node 1720 based on channel quality information fed back from any of the UE 1702 and UE 1704. The downlink resource assignment information may be sent on the PDCCH used for (e.g., assigned to) each of the UE 1702 and the UE 1704.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1706 is communicatively coupled to a core network (CN), shown as CN 1728—via an SI interface 1722. In embodiments, the CN 1728 may be an evolved packet core (EPC) network, a NextGen Packet Core (NPC) network, or some other type of CN. In this embodiment the SI interface 1722 is split into two parts: the SI-U interface 1724, which carries traffic data between the macro RAN node 1718 and the LP RAN node 1720 and a serving gateway (S-GW), shown as S-GW 1732, and an SI-mobility management entity (MME) interface, shown as SI-MME interface 1726, which is a signaling interface between the macro RAN node 1718 and LP RAN node 1720 and the MME(s) 1730.

In this embodiment, the CN 1728 comprises the MME(s) 1730, the S-GW 1732, a Packet Data Network (PDN) Gateway (P-GW) (shown as P-GW 1734), and a home subscriber server (HSS) (shown as HSS 1736). The MME(s) 1730 may be similar in function to the control plane of legacy Serving General Packet Radio Service (GPRS) Support Nodes (SGSN). The MME(s) 1730 may manage mobility aspects in access such as gateway selection and tracking area list management. The HSS 14736 may comprise a database for network users, including subscription-related information to support the network entities'handling of communication sessions. The CN 1728 may comprise one or several HSS 1736, depending on the number of mobile subscribers, on the capacity of the equipment, on the organization of the network, etc. For example, the HSS 1736 can provide support for routing/roaming, authentication, authorization, naming/addressing resolution, location dependencies, etc.

The S-GW 1732 may terminate the SI interface 1722 towards the RAN 1406, and routes data packets between the RAN 1706 and the CN 1728. In addition, the S-GW 1432 may be a local mobility anchor point for inter-RAN node handovers and also may provide an anchor for inter-3 GPP mobility. Other responsibilities may include lawful intercept, charging, and some policy enforcement.

The P-GW 1434 may terminate an SGi interface toward a PDN. The P-GW 1734 may route data packets between the CN 1728 (e.g., an EPC network) and external networks such as a network including the application server 1742 (alternatively referred to as application function (AF)) via an Internet Protocol (IP) interface (shown as IP communications interface 1738). Generally, an application server 1742 may be an element offering applications that use IP bearer resources with the core network (e.g., ETMTS Packet Services (PS) domain, LTE PS data services, etc.). In this embodiment, the P-GW 1734 is shown to be communicatively coupled to an application server 1742 via an IP communications interface 1738. The application server 1742 can also be configured to support one or more communication services (e.g., Voice-over-Internet Protocol (VoIP) sessions, PTT sessions, group communication sessions, social networking services, etc.) for the UE 1702 and the UE 1704 via the CN 1728.

The P-GW 1734 may further be a node for policy enforcement and charging data collection. A Policy and Charging Enforcement Function (PCRF) (shown as PCRF 1440) is the policy and charging control element of the CN 1728. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1740 may be communicatively coupled to the application server 1742 via the P-GW 1734. The application server 1742 may signal the PCRF 1740 to indicate a new service flow and select the appropriate Quality of Service (QoS) and charging parameters. The PCRF 1740 may provision this rule into a Policy and Charging Enforcement Function (PCEF) (not shown) with the appropriate traffic flow template (TFT) and QoS class of identifier (QCI), which commences the QoS and charging as specified by the application server 1742.

### Additional Examples

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.
Example 1 is a method for a user equipment (UE), including: detecting whether a list of Channel State Information-Reference Signal (CSI-RS) resources is configured by a network device for a non-active period of cell discontinuous transmission (DTX) cycle of the network device; and determining whether there are one or more CSI-RSs available during the non-active period of the cell DTX cycle of the network device based on a result of the detection.
Example 2 is the method of Example 1, wherein determining whether there are one or more CSI-RSs available during the non-active period of the cell DTX cycle of the network device based on the result of the detection includes: in response to detecting that a list of CSI-RS resources is configured by the network device for the non-active period of the cell DTX cycle of the network device: determining that CSI-RSs on the list of CSI-RS resources are available during the non-active period of the cell DTX cycle and determining that the CSI-RSs not on the list of CSI-RS resources are not available during the non-active period of the cell DTX cycle; or determining that the CSI-RSs on the list of CSI-RS resources are not available during the non-active period of the cell DTX cycle and determining that the CSI-RSs not on the list of CSI-RS resources are available during the non-active period of the cell DTX cycle.
Example 3 is the method of Example 1, wherein determining whether there are one or more CSI-RSs available during the non-active period of the cell DTX cycle of the network device based on the result of the detection includes: in response to detecting that no list of CSI-RS resources is configured by the network device for the non-active period of the cell DTX cycle of the network device: determining that all CSI-RSs are available during the non-active period of the cell DTX cycle; determining that no CSI-RS is available during the non-active period of the cell DTX cycle; or determining whether there are one or more CSI-RSs available during the non-active period of the cell DTX cycle of the network device based on whether cell DTX cycles are configured to align with CSI-RS cycles.
Example 4 is the method of Example 3, wherein determining whether there are one or more CSI-RSs available during the non-active period of the cell DTX cycle of the network device based on whether the cell DTX cycles are configured to align with CSI-RS cycles includes: if the cell DTX cycles are configured to align with the CSI-RS cycles, determining that no CSI-RS is available during the non-active period of the cell DTX cycle; and if the cell DTX cycles are configured not to align with the CSI-RS cycles, determining that all CSI-RSs are available during the non-active period of the cell DTX cycle.
Example 5 is the method of Example 1, further including: determining parameters for UE measurement requirement in accordance with a determination whether there are one or more CSI-RSs available during the non-active period of the cell DTX cycle of the network device.
Example 6 is the method of Example 5, further including: determining whether the UE is configured with Connected-Discontinuous Reception (C-DRX), and wherein determining the parameters for the UE measurement requirement in accordance with a determination whether there are one or more CSI-RSs available during the non-active period of the cell DTX cycle of the network device comprises: determining the parameters for the UE measurement requirement in accordance with a determination whether there are one or more CSI-RSs available during the non-active period of the cell DTX cycle and a determination whether the UE is configured with C-DRX.
Example 7 is the method of Example 6, wherein determining the parameters for the UE measurement requirement in accordance with a determination whether there are one or more CSI-RSs available during the non-active period of the cell DTX cycle and a determination whether the UE is configured with C-DRX includes: in accordance with a determination that the UE is not configured with C-DRX: in accordance with a determination that there are one or more CSI-RSs available during the non-active period of the cell DTX cycle, determining a sample interval for the corresponding UE measurement requirement as a maximum between a CSI-RS cycle and the cell DTX cycle; and in accordance with a determination that there is no CSI-RS available during the non-active period of the cell DTX cycle, determining the sample interval for the corresponding UE measurement requirement as least common multiple of the CSI-RS cycle and the cell DTX cycle; and in accordance with a determination that the UE is configured with C-DRX: in accordance with a determination that there are one or more CSI-RSs available during the non-active period of the cell DTX cycle: determining the sample interval for the corresponding UE measurement requirement as a maximum among the CSI-RS cycle, the cell DTX cycle and a UE C-DRX cycle; and determining a relaxation factor based on the UE C-DRX cycle; and in accordance with a determination that there is no CSI-RS available during the non-active period of the cell DTX cycle, determining the sample interval for the corresponding UE measurement requirement as least common multiple of the CSI-RS cycle, the cell DTX cycle, and the UE C-DRX cycle.
Example 8 is the method of Example 7, further including: determining whether the UE C-DRX cycle is greater than a predetermined threshold; and wherein determining a relaxation factor based on the UE C-DRC cycle comprises: in accordance with a determination that the UE C-DRX cycle is greater than the predetermined threshold, determining the relaxation factor as 1; and in accordance with a determination that the UE C-DRX cycle is not greater than the predetermined threshold, determining the relaxation factor being larger than 1.
Example 9 is the method of Example 1, further including: detecting whether a first time window or a second time window is configured by the network device, wherein the first time window is located in the non-active period of the cell DTX cycle, and the starting offset and ending offset of the first time window are respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle; and wherein determining whether there are one or more CSI-RSs available during the non-active period of the cell DTX cycle of the network device based on the result of the detection includes: in response to detecting that a list of CSI-RS resources is configured by the network device for the non-active period of the cell DTX cycle of the network device: in response to detecting that the first time window or the second time window is configured by the network device: determining that the CSI-RSs on the list of CSI-RS resources are available during the first time window or the second time window and determining that the CSI-RSs not on the list of CSI-RS resources are not available during the non-active period of the cell DTX cycle; or determining that the CSI-RSs not on the list of CSI-RS resources are available during the first time window or the second time window and determining that the CSI-RSs on the list of CSI-RS resources are not available during the non-active period of the cell DTX cycle.
Example 10 is the method of Example 9, wherein determining whether there are one or more CSI-RSs available during the non-active period of the cell DTX cycle of the network device based on the result of the detection further includes: in response to detecting that no list of CSI-RS resources is configured by the network device for the non-active period of the cell DTX cycle of the network device: in response to detecting that the first time window or the second window is configured by the network device, determining that all CSI-RSs falling within the first time window or the second time window are available during the non-active period of the cell DTX cycle; and in response to detecting that no first time window and second time window is configured by the network device: determining that all CSI-RSs are available during the non-active period of the cell DTX cycle; determining that no CSI-RS is available during the non-active period of the cell DTX cycle; or determining whether there are one or more CSI-RSs available during the non-active period of the cell DTX cycle of the network device based on whether the cell DTX cycles are configured to align with CSI-RS cycles.
Example 11 is the method of Example 9, wherein the first time window is configured by at least one of: a duration of the first time window; and two parameters respectively indicating the starting offset and ending offset of the first time window.
Example 12 is the method of Example 11, wherein the duration of the first time window is signal/channel specific.
Example 13 is the method of any of Examples 9-12, further including: detecting whether a time offset for the CSI-RSs on the list of CSI-RS resources is configured by the network device, wherein the time offset indicates a shift offset for the CSI-RSs such that the locations of the CSI-RSs are closer to those of Synchronization Signal Block (SSB)/CORESET 0/System Information Block (SIB)/Paging Physical Downlink Control Channel (PDCCH)/Paging Physical Downlink Share Channel (PDSCH); and in response to detecting that a time offset for the CSI-RSs on the list of CSI-RS resources is configured by the network device, shifting the CSI-RSs on the list of CSI-RS resources by the time offset.
Example 14 is the method of Example 9, further including: determining parameters for UE measurement requirement in accordance with a determination whether there are one or more CSI-RSs available during the non-active period of the cell DTX cycle of the network device, including: determining the parameters for the UE measurement requirement in accordance with a determination whether there are one or more CSI-RSs available during the non-active period of the cell DTX cycle and a determination whether the UE is configured with Connected-Discontinuous Reception (C-DRX).
Example 15 is the method of Example 14, wherein determining the parameters for the UE measurement requirement in accordance with a determination whether there are one or more CSI-RSs available during the non-active period of the cell DTX cycle and a determination whether the UE is configured with C-DRX includes: in response to detecting that the first time window is configured by the network device: in accordance with a determination that the UE is not configured with C-DRX: in accordance with a determination that there are one or more CSI-RSs available during the non-active period of the cell DTX cycle, determining a sample interval for the corresponding UE measurement requirement as a maximum between a portion of a CSI-RS cycle that falls within the first time window and the cell DTX cycle; and in accordance with a determination that there is no CSI-RS available during the non-active period of the cell DTX cycle, determining the sample interval for the corresponding UE measurement requirement as least common multiple of the CSI-RS cycle and the cell DTX cycle; and in accordance with a determination that the UE is configured with C-DRX; in accordance with a determination that there are one or more CSI-RSs available during the non-active period of the cell DTX cycle: determining the sample interval for the corresponding UE measurement requirement as a maximum among the portion of the CSI-RS cycle that falls within the first time window, the cell DTX cycle and a UE C-DRX cycle; and determining a relaxation factor based on the UE C-DRX cycle; and in accordance with a determination that there is no CSI-RS available during the non-active period of the cell DTX cycle, determining the sample interval for the corresponding UE measurement requirement as least common multiple of the CSI-RS cycle, the cell DTX cycle, and the UE C-DRX cycle.
Example 16 is the method of Example 14, wherein determining the parameters for the UE measurement requirement in accordance with a determination whether there are one or more CSI-RSs available during the non-active period of the cell DTX cycle and a determination whether the UE is configured with C-DRX includes: in response to detecting that the second time window is configured by the network device: in accordance with a determination that the UE is not configured with C-DRX: in accordance with a determination that there are one or more CSI-RSs available during the non-active period of the cell DTX cycle, determining a sample interval for the corresponding UE measurement requirement as the cell DTX cycle; and in accordance with a determination that there is no CSI-RS available during the non-active period of the cell DTX cycle, determining the sample interval for the corresponding UE measurement requirement as least common multiple of the CSI-RS cycle and the cell DTX cycle; and in accordance with a determination that the UE is configured with C-DRX; in accordance with a determination that there are one or more CSI-RSs available during the non-active period of the cell DTX cycle: determining the sample interval for the corresponding UE measurement requirement as a maximum between the cell DTX cycle and a UE C-DRX cycle; and determining a relaxation factor based on the UE C-DRC cycle; and in accordance with a determination that there is no CSI-RS available during the non-active period of the cell DTX cycle, determining the sample interval for the corresponding UE measurement requirement as least common multiple of the CSI-RS cycle, the cell DTX cycle, and the UE C-DRX cycle.
Example 17 is the method of Example 15 or 16, further comprising: determining whether the UE C-DRX cycle is greater than a predetermined threshold; and wherein determining a relaxation factor based on the UE C-DRC cycle includes: in accordance with a determination that the UE C-DRX cycle is greater than the predetermined threshold, determining the relaxation factor as 1; and in accordance with a determination that the UE C-DRX cycle is not greater than the predetermined threshold, determining the relaxation factor being larger than 1.
Example 18 is a method for a user equipment (UE), including: determining, based on a preset rule, whether there are one or more Channel State Information-Reference Signals (CSI-RSs) available during a non-active period of cell discontinuous transmission (DTX) cycle of a network device; wherein the preset rule comprises: all CSI-RSs being available during the non-active period of the cell DTX cycle; no CSI-RS being available during the non-active period of the cell DTX cycle; or whether there are one or more CSI-RSs available during the non-active period of the cell DTX cycle of the network device being based on whether the cell DTX cycles are configured to align with CSI-RS cycles.
Example 19 is the method of Example 18, further including: determining parameters for UE measurement requirement in accordance with a determination whether there are one or more CSI-RSs available during the non-active period of the cell DTX cycle of the network device.
Example 20 is a method for a network device, including: configuring, for transmission to a user equipment (UE), a list of Channel State Information-Reference Signal (CSI-RS) resources for a non-active period of cell discontinuous transmission (DTX) cycle of the network device, wherein whether there are one or more CSI-RSs available during the non-active period of the cell DTX cycle of the network device is determined based on the list of CSI-RS resources.
Example 21 is the method of Example 20, further including: configuring a first time window or a second time window for transmission to the UE, wherein the first time window is located in the non-active period of the cell DTX cycle, and the starting offset and ending offset of the first time window is respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle; and wherein whether there are one or more CSI-RSs available during the non-active period of the cell DTX cycle of the network device is further determined based on the first time window or the second window.
Example 22 is an apparatus for a user equipment (UE), the apparatus comprising: one or more processors configured to perform Steps of the method of any of Examples 1-19.
Example 21 is an apparatus for a network device, the apparatus comprising: one or more processors configured to perform Steps of the method of any of Examples 20-21.
Example 22 is an apparatus for a communication device, comprising means for performing Steps of the method according to any of Examples 1-19 or any of Examples 20-21.
Example 23 is a computer readable medium having computer programs stored thereon which, when executed by one or more processors, cause an apparatus to perform Steps of the method according to any of Examples 1-19 or any of Examples 20-21.
Example 24 is a computer program product comprising computer programs which, when executed by one or more processors, cause an apparatus to perform Steps of the method according to any of Examples 1-19 or any of Examples 20-21.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments. It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-23. (canceled)

24. A method comprising:
detecting whether a list of Channel State Information-Reference Signal (CSI-RS) resources is configured by a network device for a non-active period of cell discontinuous transmission (DTX) cycle of the network device; and
determining whether there are one or more CSI-RSs available during the non-active period of the cell DTX cycle of the network device based on said detecting whether a list of CSI-RS resources is configured by the network device.

25. The method according to claim 24, wherein detecting whether a list of CSI-RS resources is configured by the network device comprises detecting that a list of CSI-RS resources is configured by the network device for the non-active period of the cell DTX cycle and said determining whether there are one or more CSI-RSs available during the non-active period of the cell DTX cycle comprises:
determining that CSI-RSs on the list of CSI-RS resources are available during the non-active period of the cell DTX cycle and determining that the CSI-RSs not on the list of CSI-RS resources are not available during the non-active period of the cell DTX cycle; or
determining that the CSI-RSs on the list of CSI-RS resources are not available during the non-active period of the cell DTX cycle and determining that the CSI-RSs not on the list of CSI-RS resources are available during the non-active period of the cell DTX cycle.

26. The method according to claim 24, wherein detecting whether a list of CSI-RS resources is configured by the network device comprises detecting that no list of CSI-RS resources is configured by the network device for the non-active period of the cell DTX cycle and determining whether there are one or more CSI-RSs available during the non-active period of the cell DTX cycle comprises:
determining that all CSI-RSs are available during the non-active period of the cell DTX cycle;
determining that no CSI-RS is available during the non-active period of the cell DTX cycle; or
determining whether there are one or more CSI-RSs available during the non-active period of the cell DTX cycle of the network device based on whether cell DTX cycles are configured to align with CSI-RS cycles.

27. The method according to claim 26, further comprising:
determining whether there are one or more CSI-RSs available during the non-active period of the cell DTX cycle of the network device based on whether the cell DTX cycles are configured to align with CSI-RS cycles, wherein:
if the cell DTX cycles are configured to align with the CSI-RS cycles, the method further comprises determining that no CSI-RS is available during the non-active period of the cell DTX cycle; and
if the cell DTX cycles are configured not to align with the CSI-RS cycles, the method further comprises determining that all CSI-RSs are available during the non-active period of the cell DTX cycle.

28. The method according to claim 24, further comprising:
determining parameters for user equipment (UE) measurement requirement in accordance with a determination whether there are one or more CSI-RSs available during the non-active period of the cell DTX cycle of the network device.

29. The method according to claim 28, further comprising:
determining whether a UE is configured with Connected-Discontinuous Reception (C-DRX),
wherein determining the parameters for the UE measurement requirement in accordance with a determination whether there are one or more CSI-RSs available during the non-active period of the cell DTX cycle of the network device includes determining the parameters for the UE measurement requirement in accordance with a determination whether there are one or more CSI-RSs available during the non-active period of the cell DTX cycle and a determination whether the UE is configured with C-DRX.

30. The method according to claim 29, wherein determining the parameters for the UE measurement requirement in accordance with a determination whether there are one or more CSI-RSs available during the non-active period of the cell DTX cycle and a determination whether the UE is configured with C-DRX comprises:
in accordance with a determination that the UE is not configured with C-DRX:
in accordance with a determination that there are one or more CSI-RSs available during the non-active period of the cell DTX cycle, determining a sample interval for the UE measurement requirement as a maximum between a CSI-RS cycle and the cell DTX cycle; and
in accordance with a determination that there is no CSI-RS available during the non-active period of the cell DTX cycle, determining the sample interval for the UE measurement requirement as least common multiple of the CSI-RS cycle and the cell DTX cycle; and
in accordance with a determination that the UE is configured with C-DRX:
in accordance with a determination that there are one or more CSI-RSs available during the non-active period of the cell DTX cycle: determining the sample interval for the UE measurement requirement as a maximum among the CSI-RS cycle, the cell DTX cycle and a UE C-DRX cycle; and determining a relaxation factor based on the UE C-DRX cycle; and
in accordance with a determination that there is no CSI-RS available during the non-active period of the cell DTX cycle, determining the sample interval for the UE measurement requirement as least common multiple of the CSI-RS cycle, the cell DTX cycle, and the UE C-DRX cycle.

31. The method according to claim 30, further comprising:
determining whether the UE C-DRX cycle is greater than a predetermined threshold,
wherein determining a relaxation factor based on the UE C-DRX cycle includes:
in accordance with a determination that the UE C-DRX cycle is greater than the predetermined threshold, determining the relaxation factor as 1; and
in accordance with a determination that the UE C-DRX cycle is not greater than the predetermined threshold, determining the relaxation factor being larger than 1.

32. The method according to claim 30, further comprising:
detecting whether a first time window or a second time window is configured by the network device, wherein the first time window is located in the non-active period of the cell DTX cycle, and a starting offset and ending offset of the first time window are respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle,
wherein determining whether there are one or more CSI-RSs available during the non-active period of the cell DTX cycle includes:
in response to detecting that a list of CSI-RS resources is configured by the network device for the non-active period of the cell DTX cycle of the network device and in response to detecting that the first time window or the second time window is configured by the network device: determining that the CSI-RSs on the list of CSI-RS resources are available during the first time window or the second time window and determining that the CSI-RSs not on the list of CSI-RS resources are not available during the non-active period of the cell DTX cycle; or determining that the CSI-RSs not on the list of CSI-RS resources are available during the first time window or the second time window and determining that the CSI-RSs on the list of CSI-RS resources are not available during the non-active period of the cell DTX cycle.

33. The method according to claim 32, wherein determining whether there are one or more CSI-RSs available during the non-active period of the cell DTX cycle further comprises:
in response to detecting that no list of CSI-RS resources is configured by the network device for the non-active period of the cell DTX cycle of the network device:
in response to detecting that the first time window or the second window is configured by the network device, determining that all CSI-RSs falling within the first time window or the second time window are available during the non-active period of the cell DTX cycle; and
in response to detecting that no first time window and second time window is configured by the network device:
determining that all CSI-RSs are available during the non-active period of the cell DTX cycle;
determining that no CSI-RS is available during the non-active period of the cell DTX cycle; or
determining whether there are one or more CSI-RSs available during the non-active period of the cell DTX cycle of the network device based on whether the cell DTX cycles are configured to align with CSI-RS cycles.

34. The method according to claim 32, wherein the first time window is configured by: a duration of the first time window; or two parameters respectively indicating the starting offset and ending offset of the first time window.

35. The method according to claim 34, wherein the duration of the first time window is signal/channel specific.

36. The method according to claim 32, further comprising:
detecting whether a time offset for the CSI-RSs on the list of CSI-RS resources is configured by the network device, wherein the time offset indicates a shift offset for the CSI-RSs such that the locations of the CSI-RSs are closer to those of Synchronization Signal Block (SSB)/CORESET 0/System Information Block (SIB)/Paging Physical Downlink Control Channel (PDCCH)/Paging Physical Downlink Share Channel (PDSCH); and
in response to detecting that a time offset for the CSI-RSs on the list of CSI-RS resources is configured by the network device, shifting the CSI-RSs on the list of CSI-RS resources by the time offset.

37. The method according to claim 32, further comprising:
determining parameters for user equipment (UE) measurement requirement in accordance with a determination whether there are one or more CSI-RSs available during the non-active period of the cell DTX cycle of the network device, including:
determining the parameters for the UE measurement requirement in accordance with a determination whether there are one or more CSI-RSs available during the non-active period of the cell DTX cycle and a determination whether the UE is configured with Connected-Discontinuous Reception (C-DRX).

38. The method according to claim 37, wherein determining the parameters for the UE measurement requirement in accordance with a determination whether there are one or more CSI-RSs available during the non-active period of the cell DTX cycle and a determination whether the UE is configured with C-DRX comprises:
in response to detecting that the first time window is configured by the network device:
in accordance with a determination that the UE is not configured with C-DRX:
in accordance with a determination that there are one or more CSI-RSs available during the non-active period of the cell DTX cycle, determining a sample interval for the UE measurement requirement as a maximum between a portion of a CSI-RS cycle that falls within the first time window and the cell DTX cycle; and
in accordance with a determination that there is no CSI-RS available during the non-active period of the cell DTX cycle, determining the sample interval for the UE measurement requirement as least common multiple of the CSI-RS cycle and the cell DTX cycle; and
in accordance with a determination that the UE is configured with C-DRX;
in accordance with a determination that there are one or more CSI-RSs available during the non-active period of the cell DTX cycle:
determining the sample interval for the UE measurement requirement as a maximum among the portion of the CSI-RS cycle that falls within the first time window, the cell DTX cycle and a UE C-DRX cycle; and
determining a relaxation factor based on the UE C-DRX cycle; and
in accordance with a determination that there is no CSI-RS available during the non-active period of the cell DTX cycle, determining the sample interval for the UE measurement requirement as least common multiple of the CSI-RS cycle, the cell DTX cycle, and the UE C-DRX cycle.

39. The method according to claim 37, wherein determining the parameters for the UE measurement requirement in accordance with a determination whether there are one or more CSI-RSs available during the non-active period of the cell DTX cycle and a determination whether the UE is configured with C-DRX comprises:
in response to detecting that the second time window is configured by the network device:
in accordance with a determination that the UE is not configured with C-DRX:
in accordance with a determination that there are one or more CSI-RSs available during the non-active period of the cell DTX cycle, determining a sample interval for the UE measurement requirement as the cell DTX cycle; and
in accordance with a determination that there is no CSI-RS available during the non-active period of the cell DTX cycle, determining the sample interval for the UE measurement requirement as least common multiple of the CSI-RS cycle and the cell DTX cycle; and
in accordance with a determination that the UE is configured with C-DRX;
in accordance with a determination that there are one or more CSI-RSs available during the non-active period of the cell DTX cycle:
determining the sample interval for the UE measurement requirement as a maximum between the cell DTX cycle and a UE C-DRX cycle; and
determining a relaxation factor based on the UE C-DRX cycle; and
in accordance with a determination that there is no CSI-RS available during the non-active period of the cell DTX cycle, determining the sample interval for the UE measurement requirement as least common multiple of the CSI-RS cycle, the cell DTX cycle, and the UE C-DRX cycle.

40. One or more non-transitory, computer-readable media having instructions that, when executed, cause processing circuitry to:
determine, based on a preset rule, whether there are one or more Channel State Information-Reference Signals (CSI-RSs) available during a non-active period of cell discontinuous transmission (DTX) cycle of a network device;
wherein the preset rule comprises:
all CSI-RSs being available during the non-active period of the cell DTX cycle;
no CSI-RS being available during the non-active period of the cell DTX cycle; or
whether there are one or more CSI-RSs available during the non-active period of the cell DTX cycle of the network device being based on whether the cell DTX cycles are configured to align with CSI-RS cycles.

41. The one or more non-transitory, computer-readable media according to claim 40, wherein the instructions, when executed, further cause the processing circuitry to:
determine parameters for UE measurement requirement in accordance with a determination whether there are one or more CSI-RSs available during the non-active period of the cell DTX cycle of the network device.

42. An apparatus comprising:
baseband circuitry to configure, for transmission to a user equipment (UE), a list of Channel State Information-Reference Signal (CSI-RS) resources for non-active period of cell discontinuous transmission (DTX) cycle of a network device,
wherein whether there are one or more CSI-RSs available during the non-active period of the cell DTX cycle of the network device is determined based on the list of CSI-RS resources; and
interface circuitry coupled with the baseband circuitry, the interface circuitry to communicatively couple the baseband circuitry to a component of a device.

43. The apparatus according to claim 42, wherein the baseband circuitry is further to:
configure a first time window or a second time window for transmission to the UE, wherein the first time window is located in the non-active period of the cell DTX cycle, and a starting offset and ending offset of the first time window is respectively before and after Synchronization Signal Block (SSB)/CORESET 0/System Information Block (SIB)/Paging Physical Downlink Control Channel (PDCCH)/Paging Physical Downlink Share Channel (PDSCH), and wherein the second time window is located just before an active period of the cell DTX cycle,
wherein whether there are one or more CSI-RSs available during the non-active period of the cell DTX cycle of the network device is further determined based on the first time window or the second window.
